(19) United States
(12) Patent Application Publication
(10) Pub. No.: US 2022/0229401 A1
(43) Pub. Date: Jul. 21, 2022

(54) Systems and Methods for Inferring Taxonomies in Manufacturing Processes

(71) Applicant: Oden Technologies Ltd., London (GB)

(72) Inventors: Matthew Henry LINDER, Boston, MA (US); Devon PETICOLAS, Brooklyn, NY (US); Willem SUNDBLAD, Pawlet, VT (US); Deepak S. TURAGA, New City, NY (US)

(21) Appl. No.: 17/558,865

(22) Filed: Dec. 22, 2021

Related U.S. Application Data
(60) Provisional application No. 63/129,834, filed on Dec. 23, 2020.

(51) Int. Cl. G05B 13/02; G05B 13/04; G06N 5/04; G06K 9/62

(52) U.S. Cl. CPC G05B 13/0265; G06K 9/6259; G06N 5/04; G05B 13/048

(57) ABSTRACT

The present disclosure provides systems and methods for inferring knowledge about manufacturing process metrics. In an aspect, the present disclosure provides a method for inferring knowledge about manufacturing process metrics. The method may comprise: (a) receiving one or more metrics associated with a manufacturing process; and (b) using a hierarchy of models to generate one or more inferences about the manufacturing process based on the one or more metrics, wherein the hierarchy of models comprises one or more individual models and one or more ensemble models configured to generate the one or more inferences based on a combination or an aggregation of outputs generated by the one or more individual models.

### CROSS REFERENCE

This application claims priority to U.S. Provisional Patent Application No. 63/129,834 filed on Dec. 23, 2020, which application is incorporated herein by reference in its entirety for all purposes.

### BACKGROUND

Manufacturing processes may be used to fabricate various physical goods for a multitude of different end users or industrial applications. Such manufacturing processes can be generally categorized as, for example, lean manufacturing processes or just-in-time manufacturing processes. However, such general categorizations may not adequately capture important technical aspects of industrial production that are significant in distinguishing between the different manufacturing systems and methodologies used to fabricate goods

### SUMMARY

The present application relates generally to data processing systems and methods, and more particularly, to systems and methods for analyzing and optimizing manufacturing processes.

In one aspect, the present disclosure provides a method for inferring taxonomies for a manufacturing process. In another aspect, the present disclosure provides a method for inferring knowledge about manufacturing process metrics. The method may comprise: (a) receiving one or more metrics associated with a manufacturing process; and (b) using a hierarchy of models to generate one or more inferences about the manufacturing process based on the one or more metrics, wherein the hierarchy of models comprises one or more individual models and one or more ensemble models configured to generate the one or more inferences based on a combination or an aggregation of outputs generated by the one or more individual models.

In some embodiments, the one or more inferences about the manufacturing process may comprise one or more taxonomy components of the one or more metrics associated with a manufacturing process. In some embodiments, the one or more taxonomy components may comprise a kind of quantity represented by the metric, a semantic label associated with the metric, and/or a priority of the metric.

In some embodiments, generating the one or more inferences may comprise inferring a kind of quantity in a first step, inferring a semantic label in a second step, and inferring a priority in a third step.

In some embodiments, the method may further comprise training the one or more individual models to infer a kind of quantity taxonomy component from at least one of (i) an assigned metric tag, (ii) an observed metric time-series data, (iii) metric measurement configuration information, and (iv) one or more manuals provided by an equipment manufacturer.

In some embodiments, the method may further comprise training the one or more individual models to infer whether the one or more metrics can be associated with at least one instance of a semantic label taxonomy component from at least one of (i) an assigned metric tag, (ii) an observed metric time-series data, (iii) metric measurement configuration information, and (iv) a previously inferred kind of quantity.

In some embodiments, the method may further comprise training the one or more individual models to infer a relative order of priority for two or more metrics with a same inferred label from at least one of (i) an assigned metric tag, (ii) an observed metric time-series data, (iii) metric measurement configuration information, (iv) a previously inferred kind of quantity, and (v) a previously inferred semantic label.

In some embodiments, the method may further comprise using the one or more ensemble models to generate one or more final inferences for a kind of quantity by combining or aggregating two or more outputs generated using the one or more individual models.

In some embodiments, the one or more ensemble models may comprise at least one ensemble model per instance of a semantic label component. In some embodiments, the one or more ensemble models may be configured to combine (i) inference results from one or more semantic label individual models, (ii) inference results for a kind of quantity component given an inference order, and (iii) any previously user-validated kind of quantity component value for a particular metric, to generate one or more final inference results.

In some embodiments, the one or more ensemble models may comprise at least one ensemble model configured to combine or aggregate (i) a relative priority inferred by the one or more individual models for at least two metrics, with a same inferred label, and (ii) an inferred kind of quantity for each metric, to generate a final inferred priority order.

In some embodiments, the method may further comprise training the one or more individual models using at least historical data comprising assigned tag names and associated instances of a label taxonomy component. In some embodiments, the method may further comprise training the one or more individual models using at least historical data comprising observed timeseries data and associated instances of a label taxonomy component. In some embodiments, the method may further comprise training the one or more individual models using at least historical data comprising observed metric measurement configuration information and associated instances of a label taxonomy component.

In some embodiments, the method may further comprise training the one or more individual models as binary models to separate at least one instance of a label taxonomy component from all other instances of the label taxonomy component.

In some embodiments, the one or more individual models that infer an instance of a label taxonomy component may be realized as rules specified by users that map at least one of (i) tag names, (ii) time-series data, and (iii) metric measurement configuration information to (iv) the instance of the label taxonomy component.

In some embodiments, the one or more individual models that infer an instance of a label taxonomy component from metric configuration information may be trained using natural language processing techniques on (a) manuals provided by an equipment manufacturer and/or (b) a protocol specification that describe how the one or more metrics are measured, encoded, and/or communicated.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### Incorporation by Reference

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a system for inferring a taxonomy, in accordance with some embodiments.

FIG. 2 schematically illustrates inferring a taxonomy from one or more properties associated with a metric for a manufacturing process, in accordance with some embodiments.

FIG. 3 schematically illustrates inferring a kind of quantity taxonomy component using a hierarchical individual model and ensemble model approach, in accordance with some embodiments.

FIG. 4 schematically illustrates inferring a semantic label taxonomy component using a hierarchical individual modeling and ensemble model approach, in accordance with some embodiments.

FIG. 5 schematically illustrates inferring a priority taxonomy component using a hierarchical individual modeling and ensemble model approach, in accordance with some embodiments, in accordance with some embodiments.

FIG. 6 schematically illustrates a computer system that is programmed or otherwise configured to implement methods provided herein.

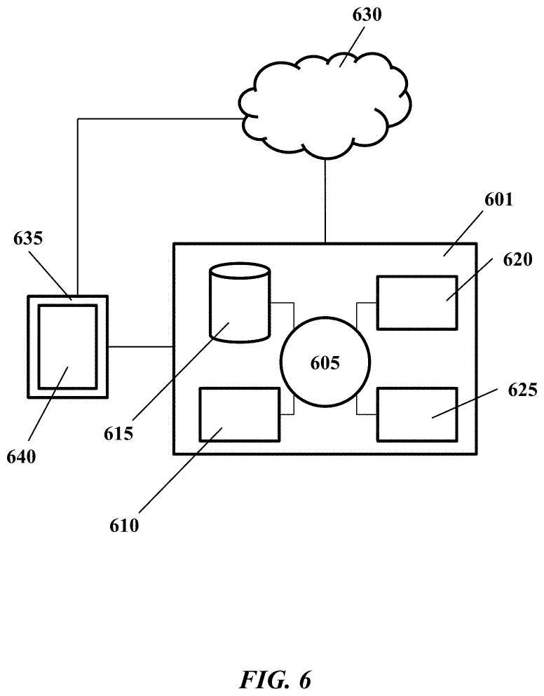

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

In an aspect, the present disclosure provides systems and methods for inferring taxonomies for one or more metrics associated with a process (e.g., an industrial process). In some cases, the industrial process may comprise, for example, a manufacturing process, a fabrication process, an assembly process, or any other process for creating a physical good or a portion thereof. Such exemplary processes may also include any mechanical, chemical, electrical, or biological processes for manufacturing, fabricating, and/or assembling a physical good (or any part or portion of such physical good).

As used herein, inferring taxonomies may comprise generating, creating, updating, modifying, and/or refining one or more taxonomies. The one or more taxonomies may comprise, for example, a classification or naming scheme for information. The information may in some cases comprise information (e.g., data or metrics) about a manufacturing process or one or more technical aspects or features of such manufacturing process. The one or more taxonomies may be configured to organize and index information. The information may correspond to an industrial process and/or any steps or procedures associated therewith. In some cases, the one or more taxonomies may be configured to organize and index information about one or more manufacturing processes. The information about the one or more manufacturing processes may be stored in various physical or virtual formats, such as documents, articles, videos, data files, etc.

The one or more taxonomies may be used by a plurality of entities (e.g., human operators or manufacturers) to more easily find, interpret, and analyze the information they are searching for. Such information may be associated with a performance of one or more steps of an industrial process such as a manufacturing process. In some cases, the one or more taxonomies may be tree structured and may divide a domain (e.g., a subject, field, or set of things the taxonomy represents) into categories based on a value, a property, or a characteristic of information or data associated with the domain.

Inferring Taxonomies

The systems and methods of the present disclosure may be implemented to infer a taxonomy for one or more metrics in a manufacturing context. The taxonomy may be used to provide insight as to what a particular metric represents regardless of the hardware (e.g., sensor or processor) and/or software used to measure or process the metric. Inferring taxonomies may provide several advantages, such as the ability to contextualize and/or standardize data, generalize analytic models for simulating, assessing, and/or analyzing one or more aspects of a manufacturing process, and reduce human effort to provide inputs to and/or configure a taxonomy.

In some cases, the taxonomy may comprise a plurality of components. The plurality of components may comprise, for example, a semantic label, a kind of quantity (along with a unit of measurement associated with the quantity), and/or a priority (e.g., a relative priority rating). In some cases, the plurality of components may further comprise one or more relationships between metrics. Such relationships may go beyond parent-child relationships, and may be used to create a full ontology (i.e., a set of concepts and categories in a subject area or domain that shows their properties and the relations between them). In some cases, the one or more relationships may comprise, for example, mathematical or statistical relationships or correlations between the metrics.

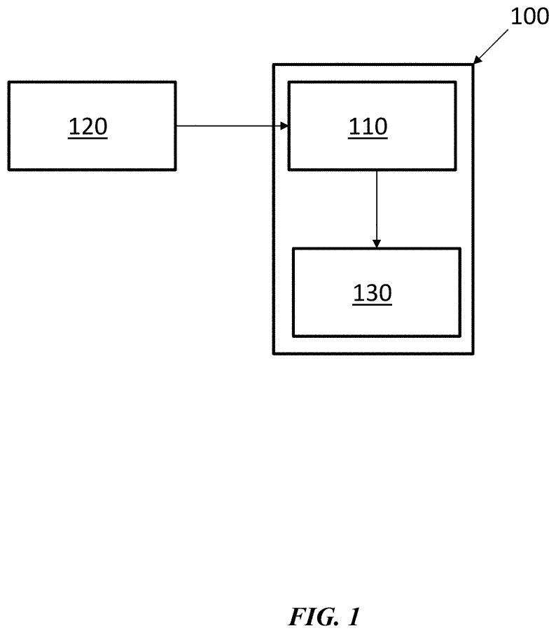

FIG. 1 illustrates a exemplary system 100 that is configured to infer a taxonomy for an industrial process (e.g., a manufacturing process). The system 100 may comprise an inference generator 110. The inference generator 110 may comprise a processor or a logic circuit that is operatively coupled to one or more sensors for measuring, observing, recording, or detecting one or more metrics associated with a manufacturing process. The inference generator 110 may be configured to infer one or more taxonomy components based on input data and metadata comprising and/or corresponding to one or more metrics associated with a manufacturing process. The inference generator 110 may be configured to infer the one or more taxonomy components using a hierarchy of models as described elsewhere herein. The one or more metrics may correspond to a quantitative and/or qualitative attribute associated with one or more steps, procedures, events, aspects, qualities, and/or features of an industrial process (e.g., a manufacturing or production run). The one or more metrics may be measured, observed, recorded, or detected using a sensor 120. In some cases, the one or more metrics may be measured, observed, recorded, or detected using a plurality of sensors comprising the sensor 120. The plurality of sensors may comprise, for example, imaging sensors, chemical detection sensors, vibration detecting sensors, electrical sensors, navigation sensors, pressure sensors, force sensors, thermal sensors, proximity sensors, combinations thereof, and/or the like.

In some cases, the system may comprise an output device 130 that is operatively coupled to the inference generator 110. The output device 130 may be configured to present the inferences to one or more users, workers, human operators, equipment supervisors, and/or manufacturers in a visual format (e.g., a chart, a graph, etc.) or a data-based format (e.g., a data file). In some cases, the output device 130 may comprise a monitor or a display. In some cases, the output device 130 may be integrated with the system 100. In other cases, the output device 130 may be remote from the system 100. The output device 130 may be operatively coupled to the inference generator 110 and/or any of the sensors described and referred to herein.

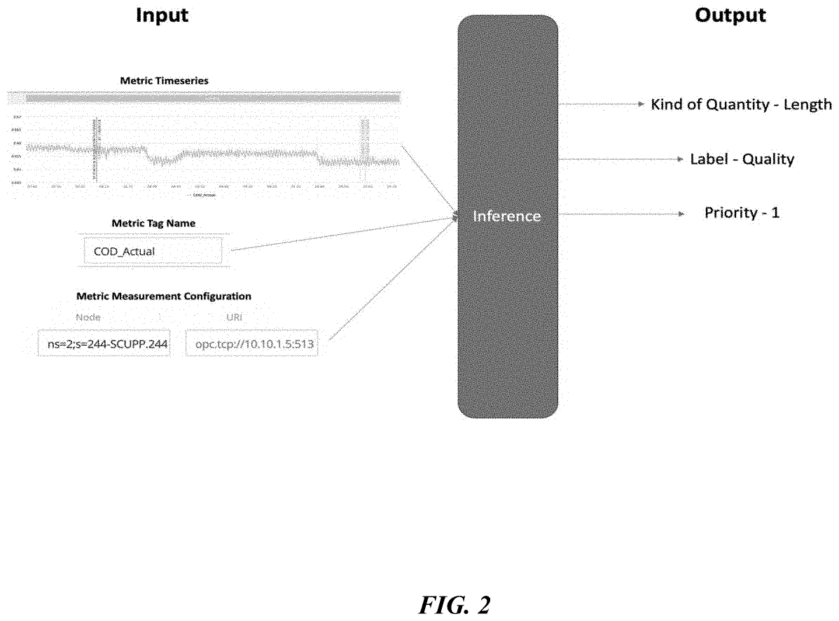

FIG. 2 illustrates an example of a method for inferring a taxonomy for a manufacturing process from properties of one or more metrics. As described elsewhere herein, the one or more metrics may be measured, observed, recorded, or detected using one or more sensors. The properties of the one or more metrics may be embodied in or represented by a time series signal associated with the metric, a tag name associated with the metric, a measurement configuration associated with the metric, and/or any data obtainable from one or more manuals or other documentation prepared, provided, and/or managed by an equipment manufacturer. The one or more manuals may comprise descriptive text or other information about the equipment or any data captured by the equipment before, during, and/or after a manufacturing process. In some cases, one or more natural language processing (NLP) based models may be used to process and/or analyze the one or more manuals to infer one or more taxonomy components as described and defined elsewhere herein. As used herein, a measurement configuration may refer to a machine to machine communication protocol that may be implemented between manufacturing equipment or two or more machines used to perform a manufacturing process. The measurement configuration may also describe one or more operational aspects or technical features relating to data capture, input/output (I/O), or communication information for a manufacturing process and/or various equipment used to perform one or more steps of the manufacturing process. The one or more metrics (and data or metadata associated with such metrics) may be used as inputs to generate one or more inferences. The one or more inferences may be used to determine a set of outputs, which set of outputs may comprise, for example, a kind of quantity (e.g., length, mass, temperature, pressure, rotations per minute, etc.), a label (e.g., quality, performance, controllable, production, etc.), and/or a priority associated with the one or more metrics.

Model Hierarchy

In some embodiments, a hierarchy of models may be implemented to infer the taxonomy components for each individual metric of interest. Such hierarchy may comprise one or more individual models and one or more ensemble models. As described elsewhere herein, the components to be inferred may include, for example, a semantic label that may be associated with the metric, a kind of quantity (e.g., a particular unit of measurement) that may be associated with a particular metric, and/or a label priority associated with the metric. In some cases, a single metric may have a plurality of labels associated with the metric, but may only have one kind of quantity associated with the metric. In some cases, there may be at most one priority associated with each of the plurality of labels associated with a metric.

Individual Models

The systems and methods disclosed herein may be implemented using one or more individual models. The individual models may be used to apply a combination of one or more data transformations (e.g., a feature extraction) to manufacturing data or metrics associated with a manufacturing process (e.g., metric timeseries, metric tag name, metric measurement configuration, and/or any data or information derived from manuals or documentation provided or prepared by equipment manufacturers), and may be configured to derive one or more inferences based on the manufacturing data or the metrics associated with a manufacturing process (e.g., by using a machine learning model-based scoring scheme, or by applying one or more pre-determined rules). The individual models may be configured to receive as an input a set of features corresponding to one or more metrics of interest. The individual models may be configured to generate one or more outputs corresponding to the inferences derived from manufacturing data or metrics associated with a manufacturing process.

Metrics

The one or more metrics of interest may comprise, for example, an assigned tag name from a programmable logic controller (PLC) and/or a display name used for the one or more metrics, time-series data associated with the one or more metrics, metric measurement configuration information (e.g. an OPC Unified Architecture configuration), and/or any text, data, or other information derived from manuals or documentation prepared, managed, or provided by an equipment manufacturer. The metric measurement configuration information may correspond to a communication protocol that can enable data exchange within a machine, between machines, and/or between machines and systems for industrial automation.

In some cases, the one or more metrics may be obtained using one or more sensors. The one or more sensors may comprise, for example, imaging sensors, chemical detection sensors, vibration detecting sensors, electrical sensors, navigation sensors, pressure sensors, force sensors, thermal sensors, proximity sensors, combinations thereof, and/or the like. In other cases, the one or more metrics may be obtained using a signal processing module (e.g., a processor or a circuit) that is configured to receive, transmit, and/or process one or more time series signals associated with a metric or a functional or technical aspect of a manufacturing process. Alternatively, the one or more metrics may be obtained by accessing a database comprising information about one or more functional or technical aspects of a manufacturing process. In some cases, the one or more metrics may be obtained from inputs, data, or other information provided by a human operator, within one or more customer satisfaction evaluations, or in relation to one or more quality assurance procedures or assessments.

In some embodiments, the metrics may comprise one or more parameters involving, but not limited to, the amount of the physical product or any part thereof such as yield, material waste, scrap, or load capacity. In some embodiments, the metrics may comprise parameters involving, but not limited to, the time required for the industrial process or any part thereof such as speed, throughput, uptime, downtime, cooling time, heating time, changeover, or transportation of material. In some embodiments, the metrics may comprise parameters involving, but not limited to, the efficiency of the industrial process or any part thereof such as labor effectiveness (i.e., managers, engineers, operators, quality assurance, employees), machinery performance (i.e., parameter tuning, lifetime, rate of degradation), percentage of process failure, production line, or physical floorplan layout. In some embodiments, the metrics may comprise parameters involving the quality level of the industrial process or any part thereof, including, for instance, process efficiency or process output yield per unit input. In some cases, the metrics may comprise extremely granular detail, such as the amount of electricity going to machines, the amount of raw material consumed, and the volume of material produced. Sensors can also capture and transmit environmental information such as temperature, humidity, and dew point so that manufacturers can identify weather-related and seasonal impacts on production.

Training

In some cases, the individual models may be trained specifically for a given customer (i.e., trained on data from other lines and on other metrics). In other cases, the individual models may be trained generically across multiple customers that have a same or similar manufacturing process type, or who use a same or similar type of equipment in their manufacturing processes. In any of the embodiments described herein, the models may be trained using artificial intelligence or one or more machine learning algorithms. In some cases, the machine learning algorithm may comprise a neural network. Examples of neural networks can include, for instance, a deep neural network (DNN), a convolutional neural network (CNN), a recurrent neural network (RNN), and/or a generative adversarial network (GAN).

In some embodiments, the machine learning algorithm may comprise a deep neural network (DNN). In other embodiments, the deep neural network may comprise a convolutional neural network (CNN). The CNN may be, for example, U-Net, ImageNet, LeNet-5, AlexNet, ZFNet, GoogleNet, VGGNet, ResNet18, or ResNet, etc. In some cases, the neural network may comprise or utilize, for example, a deep feed forward neural network, a recurrent neural network (RNN), LSTM (Long Short Term Memory), GRUs (Gated Recurrent Units), autoencoders (e.g., variational autoencoders, adversarial autoencoders, denoising autoencoders, or sparse autoencoders), a Boltzmann machine (BM), a RBM (Restricted BM), a deep belief network, a generative adversarial network (GAN), a deep residual network, a capsule network, or one or more attention/transformer networks. In some embodiments, the neural network may comprise a plurality of neural network layers. In some cases, the neural network may have at least about 2 to 1000 or more neural network layers.

In some cases, the machine learning algorithm may comprise a support vector machine (SVM), a classification algorithm, a regression analysis algorithm, or any other type of supervised, semi-supervised, or unsupervised machine learning algorithm. In some embodiments, the supervised learning algorithm may comprise or utilize, for example, support vector machine algorithms, linear regression algorithms, logistic regression algorithms, linear discriminant analysis algorithms, k-nearest neighbor algorithms, similarity learning, or any combination thereof. In some embodiments, the unsupervised learning algorithm may comprise, for example, clustering algorithms, hierarchical clustering algorithms, k-means clustering algorithms, mixture models, anomaly detection, local outlier factor algorithms, autoencoders, deep belief networks, Hebbian learning, self-organizing maps, expectation—maximization algorithms (EM), principal component analysis algorithms, independent component analysis algorithms, non-negative matrix factorization, singular value decomposition, or any combination thereof. In some cases, the machine learning algorithm may comprise or utilize a random forest, a decision tree (e.g., a boosted decision tree), a classification tree, a regression tree, a bagging tree, or a rotation forest.

Ensemble Model

In some cases, the systems and methods of the present disclosure may be implemented using one or more ensemble models. The one or more ensemble models may be configured to (i) receive one or more outputs (e.g., inferences) of each of the individual models and (ii) process (e.g., by combining or aggregating) the one or more outputs to create a final inferred taxonomy component. Besides the inference result from each individual model, the ensemble model can also receive as inputs other taxonomy components that are already inferred in a prior analysis, or that have already been validated by a user. For instance, when used to infer the priority taxonomy component, the ensemble model can also use the result about the inferred label taxonomy component as an input.

Hierarchy

Each hierarchical composition may be trained separately for different taxonomy components. For example, in some cases, a first hierarchy may be trained and/or used for the label inference, a second hierarchy may be trained and/or used for the priority inference, and a third hierarchy may be trained and/or used for the kind of quantity inference.

Types of Individual Models

The systems and methods of the present disclosure may be implemented using a plurality of individual models. The plurality of individual models may comprise, for example, a first individual model for kind of quantity taxonomy component inference, a second individual model for semantic label taxonomy component inference, and a third individual model for priority taxonomy component inference.

Kind of Quantity Individual Model

In some cases, the systems and methods of the present disclosure may use or implement a model to infer a kind of quantity that a metric represents. The kind of quantity may be defined as one of a fixed set of available mutually-exclusive categories. In some embodiments, a mutually-exclusive categories may be pre-defined, such as for a manufacturing process (e.g., temperature, pressure) and derived from or based on the International System of Quantities (ISQ). In some cases, the individual model can be trained to output one of these mutually-exclusive categories as a result of its inference.

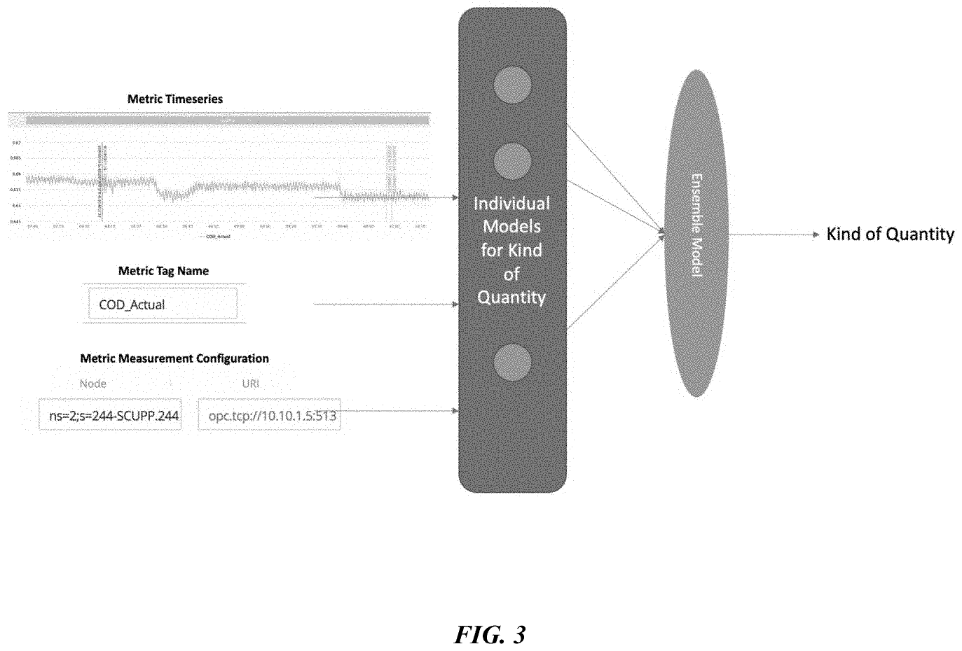

FIG. 3 schematically illustrates an example of a kind of quantity individual model. The kind of quantity individual model may be configured to (i) receive as an input a set of features corresponding to one or more metrics of interest (e.g., metric timeseries, metric tag name, metric measurement configuration, and/or any features, information, or data derived from one or more manuals provided by one or more equipment manufacturers). The kind of quantity individual model may be configured to (ii) apply an inference to (a) the one or more metrics or (b) the one or more features corresponding to the one or more metrics, to generate (c) a set of outputs comprising one or more initial inferences corresponding to a kind of quality. The one or more initial inferences may be provided to an ensemble model, which may be configured to process the one or more initial inferences to generate one or more subsequent inferences corresponding to the kind of quality.

Semantic Label Individual Models

In some cases, the systems and methods of the present disclosure may use a model to infer a semantic label associated with the metric. The semantic label may be defined as one of a fixed set of available non-exclusive categories. In some embodiments, non-exclusive categories may be pre-defined for a manufacturing process (e.g. ‘Quality’, ‘Performance’, ‘Controllable’). In some cases, an individual model may be trained to produce a binary yes/no output about whether a metric should be associated with an instance of the semantic label component. For example, a binary model may be trained to determine whether or not the metric should have a ‘Quality’ label.

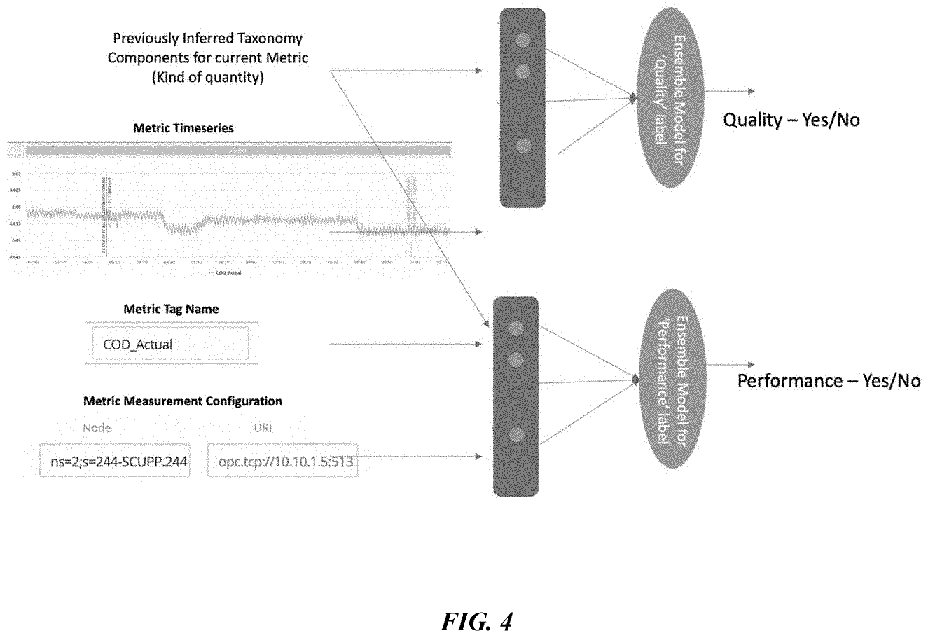

FIG. 4 schematically illustrates an example of a semantic label individual model. The semantic label individual model may be configured to (i) receive as an input a set of features corresponding to one or more metrics of interest (e.g., metric timeseries, metric tag name, and/or metric measurement configuration). The semantic label individual model may be configured to (ii) apply a plurality of inferences or previously inferred taxonomy components for a current metric (e.g., kind of quantity) to (a) one or more other metrics or (b) the one or more features corresponding to the one or more other metrics, to generate (c) a set of outputs comprising one or more initial inferences corresponding to a semantic label. The one or more initial inferences may be provided to an ensemble model, which may be configured to process the one or more initial inferences to generate one or more subsequent inferences corresponding to a semantic label. In some cases, the systems and methods of the present disclosure may be implemented using a plurality of ensemble models. The plurality of ensemble models may comprise a first ensemble model which may be configured to provide a binary output (e.g., yes/no) for a ‘Quality’ label, and a second ensemble model which may be configured to provide a binary output (e.g., yes/no) for a ‘Performance’ label.

Priority Individual Models

In some cases, the systems and methods of the present disclosure may use or implement a model to infer a priority associated with the metric, given its previously inferred semantic label. The priority individual model may permit ordering of metrics with the same semantic label in terms of their relative importance to the analysis, performance, execution, or control of the process. In some cases, the individual model may be trained to produce a relative ordering of metrics (e.g., A>=B) as an output based on one or more inputs (e.g., tag names, time-series, configuration) as well as a previously inferred kind of quantity, given that the metrics associated with the one or more inputs share a same inferred semantic label.

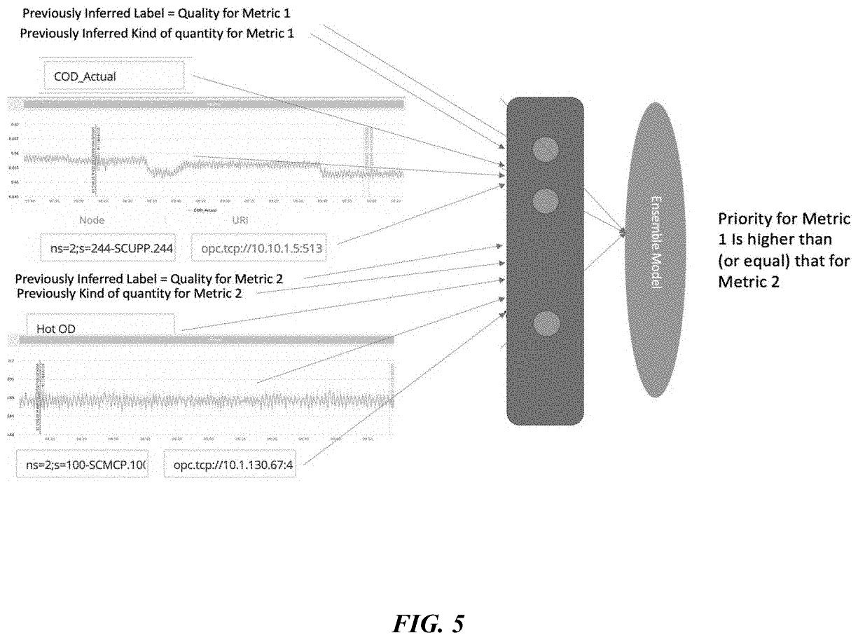

FIG. 5 schematically illustrates an example of a priority individual model. The priority individual model may be configured to (i) receive as an input a set of features corresponding to one or more metrics of interest (e.g., metric timeseries, metric tag name, and/or metric measurement configuration) or multiple sets of one or more metrics of interest. The priority individual model may be configured to (ii) apply a plurality of inferences, previously inferred taxonomy components for a current metric (kind of quantity), and/or previously inferred semantic label quality for a metric to (a) one or more other metrics or (b) the one or more features corresponding to the one or more other metrics, to generate (c) a set of outputs comprising one or more initial inferences corresponding to a metric priority. The one or more initial inferences may be provided to an ensemble model, which may be configured to process the one or more initial inferences to generate one or more subsequent inferences corresponding to a metric priority. FIG. 5 illustrates an exemplary priority individual model wherein two sets of metrics of interest and the corresponding previously inferred semantic labels and kinds of quantity for both set of metrics are provided to an ensemble model that is configured to determine and output a relative priority between the two sets of metrics.

Supervised ML Model Training

In some embodiments, the individual models (kind of quantity, semantic label, and priority) can be used to perform one or more machine learning (ML) operations. In some embodiments, the individual models (kind of quantity, semantic label, and priority) may comprise one or more machine learning models. In some embodiments, each individual machine learning model can be trained using one or more sets of labeled historical data.

In some cases, an exemplary label individual model may comprise a model that is configured to infer a label from the tag name. The model may be trained using features extracted from the tag-name and the assigned label as a set of (tag-name features, label) pairs.

In some cases, an exemplary label individual model may comprise a model that is configured to infer a label from the time-series data. The model may be trained using features extracted from the time-series as a set of (time-series features, label) pairs. As used herein, feature extraction may refer to extraction of features or temporal properties or attributes such as statistics, trends, discontinuities, time-series similarity against other standard metric timeseries, extracted motifs, and contextualized features that combine process metadata (e.g., start of a shift/run/batch/state) with the feature time-series.

In some cases, an exemplary label individual model may comprise a model that is configured to infer the label from the metric measurement configuration. The model may be trained using features extracted from the configuration for the metric, including but not limited to Data Access (register, PLC coil etc.), Alarms/Conditions, etc, represented as pairs (OPC configuration features, label).

In some cases, the training datasets used to train the models of the present disclosure may be derived only using current customer data (e.g. from other lines or manufacturing processes for the same customer and/or for different customers). In other cases, the training datasets used to train the models of the present disclosure may be derived from a plurality of prior customers. The prior customers may be involved in one or more similar or same manufacturing processes as a current customer. In some cases, the prior customers may not or need not be involved in one or more similar or same manufacturing processes as a current customer.

Rule Based Models

In some cases, the models of the present disclosure may be configured to implement one or more rule based inference techniques. In some embodiments, the models may be configured to use one or more rule based inference techniques associated with a particular OPC-UA configuration. The one or more rule based inference techniques may be derived from manuals created by the equipment manufacturer, and the corresponding rules may be extracted by parsing of the manuals using natural language processing or semi-structured data analysis. In some embodiments, the models may be configured to use one or more rule based inference techniques associated with a particular metric tag name, and may use standardized rules created by each customer to represent their naming conventions and their mapping onto taxonomy components.

Taxonomy Component Inference Order

The systems and methods of the present disclosure may further support the use of previously inferred taxonomy components for a given metric to infer a current taxonomy component for that metric. In some cases, the systems and methods of the present disclosure may be used to infer the components in the following order: (i) kind of quantity; (ii) label; (iii) priority. In some cases, the models may be configured to use the inferred kind of quantity to infer the labels of the metric, and the inferred labels and kind of quantity to infer the priority of one or more metrics.

Ensemble Model

In some embodiments, the ensemble model can be configured to use either a machine learning technique, or a rule based technique. In some embodiments, an exemplary machine-learning (ML) based ensemble model may comprise a ML based meta-model whose parameters are learned from training data. The inputs to such models may be the inference results of the individual models and the outputs of such models may be the inferred taxonomy component. In some embodiments, the ensemble model may be trained specifically for a customer or a particular manufacturing process. In some embodiments, the exemplary ensemble model may be configured to utilize rule based techniques such as Majority Voting, or Consensus Maximization, or customer specified rules to combine the results of the individual models when generating various inferences.

Continuous Learning

In some embodiments, the systems and methods of the present disclosure can further comprise the use of continuous learning. In some cases, the use continuous learning can lead to validation from its users to improve the models over time. In some cases, the systems and methods of the present disclosure can use a list or series of steps for implementing continuous learning. The steps may comprise, for example, (i) prompting a user with inference results for feedback; (ii) allowing users to accept and/or override recommendations to capture their input; (iii) incorporating feedback into the models (e.g., ensemble models and/or individual models) continuously to retrain the models; and (iv) automatically deploying retrained model based on the updates. In some cases, the systems and methods of the present disclosure may implement continuous learning to improve the individual models as well as the ensemble models.

In another aspect, the present disclosure provides a system for inferring knowledge about manufacturing process metrics, which may be represented as taxonomy components including kind of quantity, semantic label, and/or priority. The taxonomy components may be inferred in a pre-determined order. For example, in some cases, kind of quantity may be inferred first, followed by semantic label and then priority.

In some embodiments, the system may comprise a multitude of individual models that are trained to infer the kind of quantity taxonomy component from at least one of the assigned metric tag, the observed metric time-series data, the metric measurement configuration information.

In some embodiments, the multitude of individual models may each be trained to infer whether the metric can be associated with one instance of the semantic label taxonomy component from at least one of the assigned metric tag, the observed metric time-series data, the metric measurement configuration information, and the inferred kind of quantity.

In some embodiments, the multitude of individual models may each be trained to infer the relative order of priority for two or more given metrics with the same inferred label from at least one of the assigned metric tag, the observed metric time-series data, the metric measurement configuration information, and the inferred kind of quantity and inferred label.

In some embodiments, the systems and methods of the present disclosure may be used to implement a model hierarchy comprising at least one ensemble model for kind of quantity inference that combines the outputs of individual models to create a final inferred kind of quantity.

In some embodiments, the systems and methods of the present disclosure may be used to implement a model hierarchy comprising at least one ensemble model per instance of the label component that is configured to combine the inference results of the label individual models as well as results of inference of the kind of quantity component (given the inference order) and any previously user-validated kind of quantity component value for the current metric to generate a final inference result.

In some embodiments, the systems and methods of the present disclosure may be used to implement a model hierarchy comprising at least one ensemble model that combines the relative priority inferred by the individual models of two metrics, with the same inferred label, as well as the inferred kind of quantity for each metric to produce the final inferred priority order.

In some embodiments, the individual models described herein may be trained on historical data comprising assigned tag names and associated instances of label taxonomy components. In some embodiments, the individual models described herein may be trained on historical data comprising observed timeseries data and associated instances of label taxonomy components. In some embodiments, the individual models described herein may be trained on historical data comprising observed metric measurement configuration information and associated instances of label taxonomy components. In some embodiments, the individual models described herein may be trained on a combination of the data (e.g., tag names, timeseries, and/or metric measurement). In some embodiments, the individual models described herein may be trained as binary models to separate the instance of the label taxonomy component from all other instances of the label taxonomy components.

In some embodiments, the individual models described herein may be configured to infer an instance of the label taxonomy using component rules specified by users that map at least one of tag names, time-series data, and metric measurement configuration information to the instance of the label taxonomy component. In some embodiments, the individual models described herein may be configured to infer an instance of the label taxonomy component from metric configuration information, and may be trained using natural language processing techniques performed on manuals provided by the equipment manufacturer or protocol specifications that describe how the metrics are measured, encoded and communicated.

Computer Systems

In an aspect, the present disclosure provides a computer system 601 that is programmed or otherwise configured to implement methods of the disclosure. In some cases, the computer system may be configured to (i) receive as an input a set of features corresponding to one or more metrics of interest (e.g., metric timeseries, metric tag name, and/or metric measurement configuration); (ii) apply one or more rules or machine learning operations to (a) the one or more metrics or (b) the one or more features corresponding to the one or more metrics, to generate (c) a set of outputs comprising one or more initial inferences. The one or more initial inferences may be provided to an ensemble model, which may be configured to process the one or more initial inferences to generate one or more subsequent inferences. The computer system 601 can be an electronic device of a user or a computer system that is remotely located with respect to the electronic device. The electronic device can be a mobile electronic device.

The computer system 601 may include a central processing unit (CPU, also “processor” and “computer processor” herein) 605, which can be a single core or multi core processor, or a plurality of processors for parallel processing. The computer system 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 can be a data storage unit (or data repository) for storing data. The computer system 601 can be operatively coupled to a computer network (“network”) 630 with the aid of the communication interface 620. The network 630 can be the Internet, an internet and/or extranet, or an intranet and/or extranet that is in communication with the Internet. The network 630 in some cases is a telecommunication and/or data network. The network 630 can include one or more computer servers, which can enable distributed computing, such as cloud computing. The network 630, in some cases with the aid of the computer system 601, can implement a peer-to-peer network, which may enable devices coupled to the computer system 601 to behave as a client or a server.

The CPU 605 can execute a sequence of machine-readable instructions, which can be embodied in a program or software. The instructions may be stored in a memory location, such as the memory 610. The instructions can be directed to the CPU 605, which can subsequently program or otherwise configure the CPU 605 to implement methods of the present disclosure. Examples of operations performed by the CPU 605 can include fetch, decode, execute, and writeback.

The CPU 605 can be part of a circuit, such as an integrated circuit. One or more other components of the system 601 can be included in the circuit. In some cases, the circuit is an application specific integrated circuit (ASIC).

The storage unit 615 can store files, such as drivers, libraries and saved programs. The storage unit 615 can store user data, e.g., user preferences and user programs. The computer system 601 in some cases can include one or more additional data storage units that are located external to the computer system 601 (e.g., on a remote server that is in communication with the computer system 601 through an intranet or the Internet).

The computer system 601 can communicate with one or more remote computer systems through the network 630. For instance, the computer system 601 can communicate with a remote computer system of a user (e.g., a human operator, a manufacturing engineer, a manufacturing technician, a quality assurance specialist, a manufacturer, an employee of a manufacturing company, etc.). Examples of remote computer systems include personal computers (e.g., portable PC), slate or tablet PC's (e.g., Apple® iPad, Samsung® Galati Tab), telephones, Smart phones (e.g., Apple® iPhone, Android-enabled device, Blackberry®), or personal digital assistants. The user can access the computer system 601 via the network 630.

Methods as described herein can be implemented by way of machine (e.g., computer processor) executable code stored on an electronic storage location of the computer system 601, such as, for example, on the memory 610 or electronic storage unit 615. The machine executable or machine readable code can be provided in the form of software. During use, the code can be executed by the processor 605. In some cases, the code can be retrieved from the storage unit 615 and stored on the memory 610 for ready access by the processor 605. In some situations, the electronic storage unit 615 can be precluded, and machine-executable instructions are stored on memory 610.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 601 can include or be in communication with an electronic display 635 that comprises a user interface (UI) 640 for users to monitor metrics and/or view inferences generated based on any of the metrics described herein. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 605. For example, the algorithm may be configured to (i) receive as an input a set of features corresponding to one or more metrics of interest (e.g., metric timeseries, metric tag name, and/or metric measurement configuration); (ii) apply one or more rules or machine learning operations to (a) the one or more metrics or (b) the one or more features corresponding to the one or more metrics, to generate (c) a set of outputs comprising one or more initial inferences; and (iii) use an ensemble model to process the one or more initial inferences to generate one or more subsequent inferences.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for inferring knowledge about manufacturing process metrics, comprising:
(a) receiving one or more metrics associated with a manufacturing process; and
(b) using a hierarchy of models to generate one or more inferences about the manufacturing process based on the one or more metrics,
wherein the hierarchy of models comprises one or more individual models and one or more ensemble models configured to generate the one or more inferences based on a combination or an aggregation of outputs generated by the one or more individual models.

2. The method of claim 1, wherein the one or more inferences about the manufacturing process comprise one or more taxonomy components of the one or more metrics.

3. The method of claim 2, wherein the one or more taxonomy components comprise a kind of quantity represented by the metric, a semantic label associated with the metric, and/or a priority of the metric.

4. The method of claim 1, wherein generating the one or more inferences comprises inferring a kind of quantity in a first step, inferring a semantic label in a second step, and inferring a priority in a third step.

5. The method of claim 1, further comprising training the one or more individual models to infer a kind of quantity taxonomy component from at least one of (i) an assigned metric tag, (ii) an observed metric time-series data, (iii) metric measurement configuration information, and (iv) one or more manuals provided by an equipment manufacturer.

6. The method of claim 1, further comprising training the one or more individual models to infer whether the one or more metrics can be associated with at least one instance of a semantic label taxonomy component from at least one of (i) an assigned metric tag, (ii) an observed metric time-series data, (iii) metric measurement configuration information, and (iv) a previously inferred kind of quantity.

7. The method of claim 1, further comprising training the one or more individual models to infer a relative order of priority for two or more metrics with a same inferred label from at least one of (i) an assigned metric tag, (ii) an observed metric time-series data, (iii) metric measurement configuration information, (iv) a previously inferred kind of quantity, and (v) a previously inferred semantic label.

8. The method of claim 1, further comprising using the one or more ensemble models to generate one or more final inferences for a kind of quantity by combining or aggregating two or more outputs generated using the one or more individual models.

9. The method of claim 1, wherein the one or more ensemble models comprise at least one ensemble model per instance of a semantic label component,
wherein the one or more ensemble models are configured to combine (i) inference results from one or more semantic label individual models, (ii) inference results for a kind of quantity component given an inference order, and (iii) any previously user-validated kind of quantity component value for a particular metric, to generate one or more final inference results.

10. The method of claim 1, wherein the one or more ensemble models comprise at least one ensemble model configured to combine (i) a relative priority inferred by the one or more individual models for at least two metrics, with a same inferred label, and (ii) an inferred kind of quantity for each metric, to generate a final inferred priority order.

11. The method of claim 1, further comprising training the one or more individual models using at least historical data comprising assigned tag names and associated instances of a label taxonomy component.

12. The method of claim 1, further comprising training the one or more individual models using at least historical data comprising observed timeseries data and associated instances of a label taxonomy component.

13. The method of claim 1, further comprising training the one or more individual models using at least historical data comprising observed metric measurement configuration information and associated instances of a label taxonomy component.

14. The method of claim 1, further comprising training the one or more individual models as binary models to separate at least one instance of a label taxonomy component from all other instances of the label taxonomy component.

15. The method of claim 1, wherein the one or more individual models that infer an instance of a label taxonomy component are realized as rules specified by users that map at least one of (i) tag names, (ii) time-series data, and (iii) metric measurement configuration information to (iv) the instance of the label taxonomy component.

16. The method of claim 1, wherein the one or more individual models that infer an instance of a label taxonomy component from metric configuration information are trained using natural language processing techniques on (a) manuals provided by an equipment manufacturer or (b) a protocol specification that describes how the one or more metrics are measured, encoded, and/or communicated.
